(19) United States
(12) Patent Application Publication
(10) Pub. No.: US 2018/0285057 A1
(43) Pub. Date: Oct. 4, 2018

(54) MEDIA POPULARITY TRACKER

(71) Applicants: Norbert Lazar, Wexford, PA (US); Jodie J. Spade, Rochester, PA (US)

(72) Inventors: Norbert Lazar, Wexford, PA (US); Jodie J. Spade, Rochester, PA (US)

(21) Appl. No.: 15/474,712

(22) Filed: Mar. 30, 2017

(51) Int. Cl. G06F 3/16; G06F 17/30

(52) U.S. Cl. CPC G06F 3/165; G06F 17/30026

(57) ABSTRACT

One embodiment provides a method, including: receiving, at an information handling device, an indication to play a media file, wherein the media file begins playing at a first volume; receiving, at an input device of the information handling device, volume adjustment input from a user during a duration of the media file; adjusting, based on the volume adjustment input, a volume setting of the information handling device from the first volume to a second volume; determining, using a processor, that the volume adjustment input is associated with a user's disposition towards the media file; and recording, based on the determining, the user's disposition towards the media file in a database. Other aspects are described and claimed.

### BACKGROUND

Information handling devices (“devices”), for example, smart phones, tablet devices, laptop computers, smart speakers, and the like, are capable of playing various types of media files (e.g., songs, videos, etc.) and providing audible output (e.g., through speakers, other output devices, etc.) associated with the media. Users utilizing a media playing application (e.g., Pandora®, Spotify®, YouTube®, etc.) to listen to the media have the ability to provide an indication as to whether or not they like the media file being playing. The user provided indication may be recorded and referenced at a later time to provide the user with additional content (e.g., suggestions for similar media files, related advertisements, other associated content, etc.).

### BRIEF SUMMARY

In summary, one aspect provides a method, comprising: receiving, at an information handling device, an indication to play a media file, wherein the media file begins playing at a first volume; receiving, at an input device of the information handling device, volume adjustment input from a user during a duration of the media file; adjusting, based on the volume adjustment input, a volume setting of the information handling device from the first volume to a second volume; determining, using a processor, that the volume adjustment input is associated with a user's disposition towards the media file; and recording, based on the determining, the user's disposition towards the media file in a database.

Another aspect provides an information handling device, comprising: a processor; a memory device that stores instructions executable by the processor to: receive an indication to play a media file, wherein the media file begins playing at a first volume; receive volume adjustment input from a user during a duration of the media file; adjust a volume setting of the information handling device from the first volume to a second volume; determine that the volume adjustment input is associated with a user's disposition towards the media file; and record, based on the determining, the user's disposition towards the media file in a database.

A further aspect provides a method, comprising: receiving, at an information handling device, an indication to play a media file; receiving, at an input device of the information handling device, another indication to perform another action on the media file, wherein the another indication is received during at least one of: the completion of the media file and during a duration of the media file; determining, using a processor, that the another action is associated with a user's disposition towards the media file and recording, based on the determining, the user's disposition towards the media file in a database.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of tracking media file popularity based upon volume adjustment.

FIG. 4 illustrates an example method of tracking media file popularity based on user actions on the media file.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally, many media playing applications include clickable “like” and “dislike” icons that enable users to identify whether or not they like the media being played on the application. For example, a user listening to a song-cycling application (e.g., Pandora®, Spotify®, a radio application, etc.) may select (e.g., using touch input, stylus input, mouse input, etc.) a “like” icon when a song begins playing that they enjoy. The selection of the “like” icon may signify that a user likes that song or song type. Alternatively, a selection of a “dislike” icon may signify that a user does not like that song or song type.

However, these conventional methods require a user to interact with a display screen associated with a device. In some situations, a user may be unable to interact with a display screen to indicate their approval or disapproval for a particular piece of media. For example, a user may be engaged in an activity where either their hands, visual focus, or both are required elsewhere (e.g., while driving, exercising, etc.). In another example, a user may be blind, or have limited vision, and may be unable to identify, differentiate, and/or interact with the icons and content displayed on the display screen.

Existing solutions may allow a user to indicate their approval or disapproval for a piece of media vocally. For example, a user listening to a song may provide the vocal input “I like this song.” Responsive to detecting the user's vocal statement or command, a device may record a “like” selection for the song the user was listening to. However, these existing solutions may be inappropriate in various scenarios. For example, a user may be in a quiet environment (e.g., driving in a car with sleeping passengers, studying in a library, etc.) where voice commands may disturb other people in the vicinity. Additionally, a user may not want to disrupt the song by speaking over the lyrics and the music of the song.

Accordingly, an embodiment provides a method for tracking a user's disposition towards a particular media file based on received volume adjustment input. In an embodiment, an indication to play a particular media file may be received at a device. The media file may begin playing at a first volume. An embodiment may receive volume adjustment input from the user to adjust a volume setting of the device from the first volume to a second volume (e.g., a higher volume or a lower volume). Based on the volume adjustment, an embodiment may determine that the volume adjustment input is associated with a user's disposition (e.g., approval, disapproval, etc.) towards the media file. Such a method enables devices, or applications running on devices, to track and record a user's disposition towards a media file in a more natural way and without requiring the user to provide additional input to indicate their disposition.

Another embodiment provides a method for tracking a user's disposition towards a particular media file based on user input during or after a duration of the media file. In an embodiment, an indication to play a particular media file may be received at a device. An embodiment may then receive another indication to perform another action on the media file (e.g., restart the media file, skip the media file, etc.) during a duration of the media file or after completion of the media file (e.g., immediately after completion of the media file, within a predetermined time threshold after completion of the media file, when a subsequent media file starts playing, etc.). An embodiment may then determine that the indication to perform another action may be associated with a positive or negative disposition a user has towards the media file and an embodiment may record the user's disposition in a database. Such a method enables devices, or applications running on devices, to track and record a user's disposition towards a media file in a more natural way.

The illustrated example embodiments will be best understood by reference to the figures. The following description is intended only by way of example, and simply illustrates certain example embodiments.

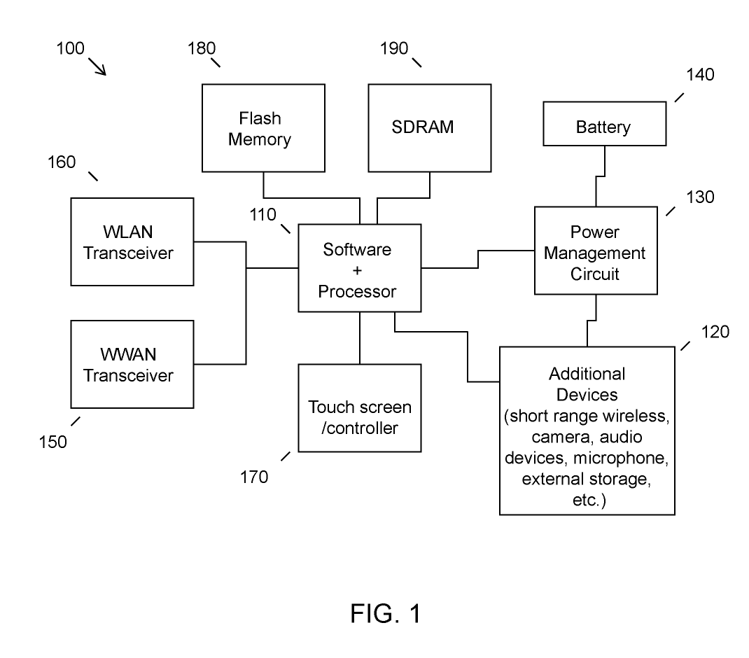

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

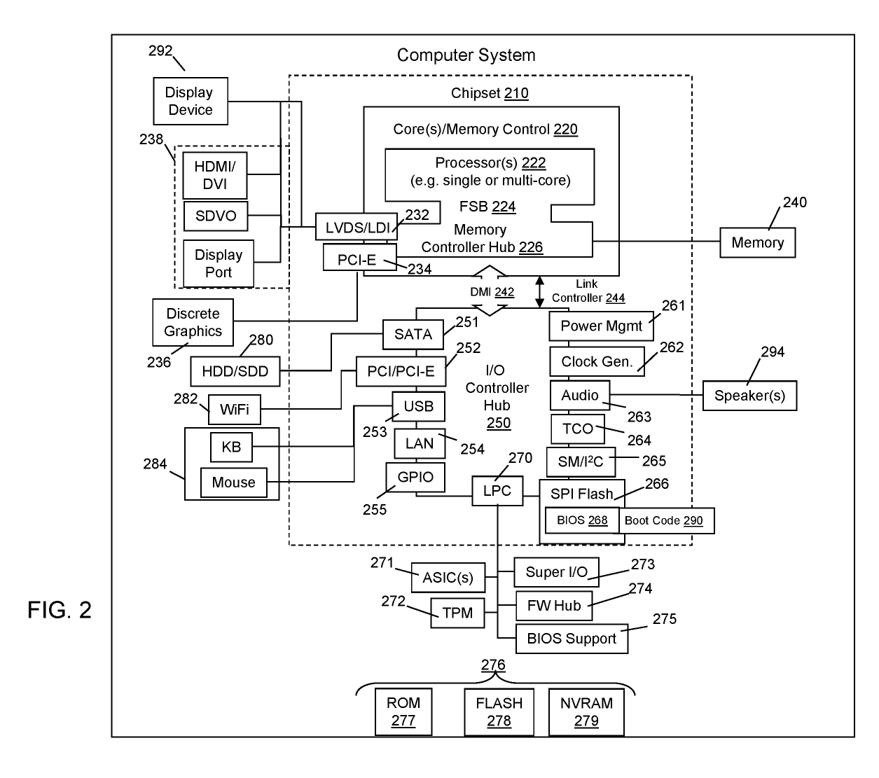

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices which may be used by a user to listen to or consume media files and/or to determine and record a user's disposition towards a media file. For example, the circuitry outlined in FIG. 1 may be implemented in a tablet or smart phone embodiment, whereas the circuitry outlined in FIG. 2 may be implemented in a personal computer embodiment.

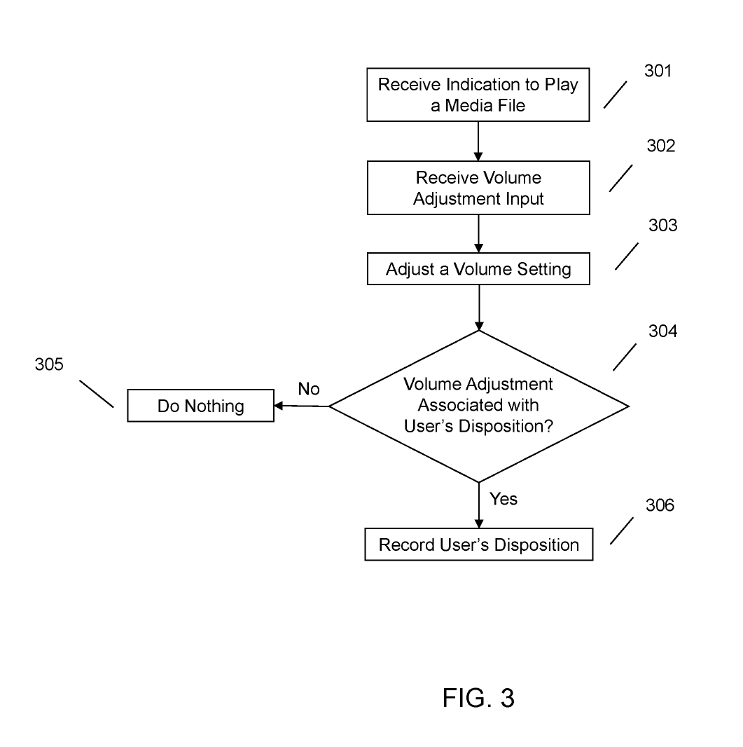

Referring now to FIG. 3, an embodiment may determine a user's disposition towards a particular media file based upon volume adjustment input provided by a user. At 301, an embodiment may receive an indication to play a media file at an information handling device. In an embodiment, the media file may be associated with any kind of media such as audio (e.g., songs, audiobooks, etc.), video (e.g., music videos, other video clips, etc.), a combination thereof, etc. In an embodiment, the indication may derive from user input (e.g., voice input, touch input, stylus input, mouse input, etc.) provided to an input device (e.g., microphone, touch screen, etc.) associated with the device to play the media file. In an embodiment, the input device may be integral to the device. For example, the input device may be a microphone or keyboard integrated into the device. Alternatively, the input device may be operatively coupled to the device via a wireless or wired connection. For example, voice input may be captured using a microphone integral to a user device and then transmitted to another device for processing via a wired or wireless connection. In an embodiment, the user provided input may be user provided play input. For example, user provided play input may include a user touching a “play” icon disposed on a display screen associated with the device, a user vocally providing the input “play song” to a microphone associated with the device, and the like.

Alternatively, in another embodiment, the indication may not derive from user input. Media cycling applications (e.g., Pandora®, Spotify®, YouTube ®, a radio playing application, another type of media playlist, etc.) may play media files one after the other without additional input from a user. For instance, using musical media files as an example, once a song is completed another song may automatically be played. The subsequent song does not require additional user provided play input to begin. In such a situation, the indication may be received when the next song automatically begins playing. Some media cycling applications may play media within a queue, for example, a playlist created by a user, or may play media based upon a user's disposition towards the media. For example, if a user indicates they like a song, the system may play related or similar songs. The related or similar songs may be based upon the artist, genre, rhythms, frequencies, user chosen similar songs, and the like.

In an embodiment, the media file may begin playing at a first volume. The first volume may be a predefined volume set by the device or it may be set by a user. For example, the first volume may be an existing volume setting on the device when the media file is played. In another example, the first volume may be predefined (e.g., each media file begins playing at X volume level, at a particular time of day or environmental setting the media file plays at Y volume, the volume is based upon an output device type, etc.). For example, if a user is listening to the media file using headphones, the volume may be different than if the user is listening to the media file using speakers.

At 302, an embodiment may receive volume adjustment input from a user during a duration of the media file. Volume adjustment input refers to input from a user intended to either increase or decrease the output volume of a device. For example, an increasing input may refer to input that increases the volume setting on the device, which thereby causes an output device (e.g., a speaker, headphones, another output device, etc.) to provide output at a louder decibel. Alternatively, a decreasing input may refer to input that decreases the volume setting on the device, which thereby causes an output device to provide output at a lower decibel.

In an embodiment, the volume adjustment input may be received the same way user-provided play input is received. For example, the volume adjustment input may be received by voice input, touch input, stylus input, mouse input, or the like, and it may be provided to an input device (e.g., microphone, touch screen, keyboard, trackpad, mouse, adjustment wheel, pushbutton, etc.) associated with the device. In an embodiment, the volume adjustment input may be received through different methods as well, such as by physical buttons disposed either on the device or other peripheral devices operatively coupled to the device. For example, a user may press physical volume adjustment buttons disposed on a device (e.g., located on the side of the device, etc.) or disposed on headphones coupled to the device. As another example, for users who are driving a vehicle, the physical volume adjustment buttons may be located at an accessible location within the user's reach (e.g., disposed on the steering wheel, located on the media console, etc.).

At 303, an embodiment may adjust a volume setting of the device from a first volume to a second volume based on the received volume adjustment input. For example, responsive to identifying that the volume adjustment input comprises a volume increasing input, an embodiment may increase the volume setting of the device to a second volume, where the second volume is greater than the first volume. Alternatively, responsive to identifying that the volume adjustment input comprises a volume decreasing input, an embodiment may decrease the volume setting of the device to a second volume, where the second volume is lower than the first volume. Responsive to determining that the volume adjustment input is not associated with a user's disposition towards a media file, an embodiment may, at 305, do nothing. For example, if the system determines that the user is merely adjusting the volume to account for surrounding noise or to set the volume for the particular user, the system may do nothing. In other words, if the system determines that the volume adjustment is not based upon how the user feels towards the media file, the system may take no action with regard to the media file.

At 304, an embodiment may determine that the volume adjustment input is associated with a disposition the user has towards the media file. The disposition may be a positive disposition (e.g., indicating that the user likes the media file) or the disposition may be a negative disposition (e.g., indicating that the user does not like the media file).

In an embodiment, the determination may be made by identifying whether the second volume is higher or lower than the first volume. For example, if the second volume is higher than the first volume, thereby indicating that a user has provided increasing volume input, an embodiment may determine that the user has a positive disposition towards the media file. Conversely, if the second volume is lower than the first volume, thereby indicating that a user has provided decreasing volume input, an embodiment may determine that the user has a negative disposition towards the media file. Such a determination may fall in line with natural reactions an individual may have to a media file. For example, in the case of songs, many individuals increase the volume when a song comes on that they enjoy and decrease the volume when a song comes on that they do not enjoy.

In an embodiment, the determination may be made by identifying at what point during the duration of the media file the volume was adjusted from the first volume to the second volume. For example, if the second volume is higher than the first volume and if the volume was increased at the beginning of a media file's duration, then an embodiment may determine that a user has a positive disposition towards the media file. Conversely, if the second volume is lower than the first volume and if the volume was decreased at the beginning of a media file's duration, then an embodiment may determine that a user has a negative disposition towards the media file. In an embodiment, the “beginning” of a media file's duration may correspond to a predefined time limit (e.g., the first 5 seconds of the media file, the first 10 seconds of the media file, etc.) that an adjustment action must take place within in order to be considered relevant to a user's disposition. Such a determination may fall in line with natural reactions an individual may have to a media file. For example, in the case of songs, when a song begins playing that an individual enjoys, that individual may turn the song up immediately (e.g., within the first few seconds of the songs, etc.).

In an embodiment, the determination may be made by identifying the volume adjustment actions taken on a subsequently played media file. An embodiment may receive an indication to play another media file directly after the current media file ends (e.g., from a user input action, from automatic cycling through a playlist, etc.) and may receive volume adjustment input from the user during a duration of the subsequent media file. The volume adjustment input may adjust the volume setting of the device from the second volume to a third volume. In an embodiment, the determination may be made by identifying whether the third volume is higher or lower than the second volume.

For example, if the second volume is higher than the first volume and the third volume is lower than the second volume this indicates that a user has provided decreasing volume input during the duration of the subsequent media file. Such an action may be an indication that a user enjoyed the previous media file (so they increased the volume) but does not enjoy the current media file as much. Conversely, if the second volume is lower than the first volume and the third volume is higher than the second volume this indicates that a user has provided increasing volume input during the duration of the subsequent media file. Such an action may be an indication that a user did not enjoy the previous media file (so they decreased the volume) but enjoys the current media file better.

In an embodiment, all of the aforementioned methods of determining a user's disposition towards a media file based on volume adjustment input may be utilized separately or in combination.

Responsive to determining, at 304, that the volume adjustment input is associated with a user's disposition towards a media file, an embodiment may record, or store, at 306, the user's disposition toward the media file in a database. In an embodiment, the user's disposition may be stored locally (e.g., on the device), remotely (e.g., the cloud, network storage location, etc.), or a combination thereof.

In an embodiment, based on the user's recorded disposition toward a particular media file, an embodiment may provide the user with additional information or content. For example, for a recorded positive disposition, an embodiment may provide the user with suggestions for similar types of media (e.g., similar songs, similar videos, etc.), may automatically play similar types of media (e.g., on the song-cycling application, on the playlist, etc.), may provide the user with advertisement information associated with the media file, etc. Alternatively, for a recorded negative disposition, an embodiment may avoid suggesting or playing media files associated with the media file having a negative connotation.

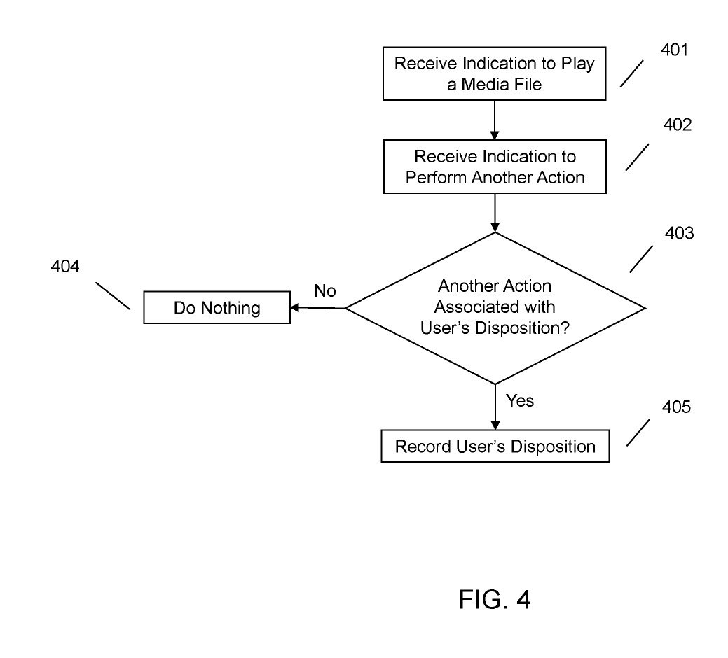

Referring now to FIG. 4, an embodiment may determine a user's disposition towards a particular media file based upon another action performed by the user on the media file. At 401, an embodiment may receive an indication to play a media file using methods and devices previously elaborated upon in 301.

At 402, an embodiment may receive an indication to perform another action associated with the media file. In an embodiment, the other action may be provided by the user and may be a restart action (e.g., to restart the media file from the beginning), a skip action (e.g., to skip to the next media file available), a change channel action (e.g., to change the station to a different channel, etc.), and the like. In an embodiment, the other action may be provided either during the duration of the media file or at the completion of the media file. For example, the restart action may be provided by a user at the end of a duration of a media file or after the media file has concluded. In another example, the skip and change channel actions may be provided during the duration of the media file.

At 403, an embodiment may determine that the other action is associated with a disposition the user has towards the media file. For example, a restart action may be associated with a positive disposition because a user that restarts a song likely enjoyed listening to it. In another example, the skip action may be associated with a negative disposition because a user that skips a song likely did not enjoy listening to it. In a further example, the change channel reaction may be associated with a negative disposition because a user that changes a channel during a duration of the media file likely did not enjoy listening to it. Responsive to determining that the other action is not associated with a user's disposition towards a media file, an embodiment may, at 404, do nothing.

Responsive to determining, at 403, a user's disposition towards a media file, an embodiment may record, or store, at 405, the user's disposition toward the media file in a database. An embodiment may record the user's disposition toward the media file and provide additional information, or content, using methods and devices previously elaborated upon in 306. Additionally, determining the user's disposition towards a media file may be based upon one or more of the above mentioned actions. For example, a user who really likes a song may not only increase the volume during the duration of the song, but may also repeat the song close to or after the ending of the song. Accordingly, an embodiment may use both indications to determine the disposition of the user towards the media file.

The various embodiments described herein thus represent a technical improvement to tracking a user's disposition towards a media file. Using the techniques described herein, an embodiment may determine a user's disposition toward a media file and subsequently record that disposition to provide the user with additional information, or content, at a later time. Such techniques provide a natural way of tracking the types of media files a user likes, or dislikes, without requiring the user to provide additional input to indicate their disposition.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an information handling device, an indication to play a media file, wherein the media file begins playing at a first volume;
receiving, at an input device of the information handling device, volume adjustment input from a user at a beginning of a duration of the media file;
adjusting, based on the volume adjustment input, a volume setting of the information handling device from the first volume to a second volume, wherein the second volume is higher than the first volume;
determining, using a processor, that the volume adjustment input is associated with a positive user disposition towards the media file; and
recording, based on the determining, the user's disposition towards the media file in a database.

2.-5. (canceled)

6. The method of claim 1, further comprising:
receiving an indication to play another media file directly after the media file, wherein the another media file begins playing at the second volume;
receiving volume adjustment input from the user during a duration of the another media file; and
adjusting, based on the volume adjustment input, the volume setting of the information handling device from the second volume to a third volume;
wherein the third volume is lower than the second volume and wherein the determining comprises determining, based on the adjusting the volume setting to the third volume, that the disposition comprises a positive disposition.

7.-9. (canceled)

10. The method of claim 1, further comprising providing, based on the recorded disposition, additional content to the user.

11. An information handling device, comprising:
a processor;
a memory device that stores instructions executable by the processor to:
receive an indication to play a media file, wherein the media file begins playing at a first volume;
receive volume adjustment input from a user at a beginning of a duration of the media file;
adjust a volume setting of the information handling device from the first volume to a second volume, wherein the second volume is higher than the first volume;
determine that the volume adjustment input is associated with a positive user disposition towards the media file; and
record, based on the determining, the user's disposition towards the media file in a database.

12.-15. (canceled)

16. The information handling device of claim 11, wherein the instructions are further executable by the processor to:
receive an indication to play another media file directly after the media file, wherein the another media file begins playing at the second volume;
receive volume adjustment input from the user during a duration of the another media file; and
adjust, based on the volume adjustment input, the volume setting of the information handling device from the second volume to a third volume;
wherein the third volume is lower than the second volume and wherein the instructions executable by the processor to determine comprise instructions executable by the processor to determine, based on the instructions executable by the processor to adjust the volume setting to the third volume, that the disposition comprises a positive disposition.

17. (canceled)

18. A method, comprising:
receiving, at an information handling device, an indication to play a media file;
receiving, at an input device of the information handling device, another indication to perform another action associated with the media file, wherein the another indication is received during at least one of: the completion of the media file and during a duration of the media file;
determining, using a processor, that the another action is associated with a user's disposition towards the media file and recording, based on the determining, the user's disposition towards the media file in a database.

19. The method of claim 18, wherein the another action comprises a restart action and wherein the user's disposition comprises a positive disposition.

20. The method of claim 18, wherein the another action comprises a skip action and wherein the user's disposition comprises a negative disposition.
